(19) United States
(12) Patent Application Publication
(10) Pub. No.: US 2026/0093675 A1
(43) Pub. Date: Apr. 2, 2026

(54) SYSTEM AND METHOD FOR ENHANCING DATA FIELDS IN STRUCTURED DATA FILES OF PROPERTY LISTINGS

(71) Applicant: PROPIC PTY LTD, Sydney (AU)

(72) Inventors: Patrick HILL, Sydney (AU); Jeffery GRAY, Sydney (AU)

(21) Appl. No.: 19/410,778

(22) Filed: Dec. 5, 2025

Related U.S. Application Data
(63) Continuation of application No. PCT/AU2024/050957, filed on Sep. 6, 2024.

(30) Foreign Application Priority Data
Sep. 8, 2023 (AU) 2023902896

(51) Int. Cl. G06F 16/215; G06F 16/245; G06F 16/55; G06Q 50/163

(52) U.S. Cl. CPC G06F 16/215; G06F 16/245; G06F 16/55; G06Q 50/163

(57) ABSTRACT

A system is provided for enhancing data fields within exchangeable structured data files of property listings. The system includes a server connected to a property management system via a wide area network. The server comprises a processor executing controllers, including a data extraction and parsing controller that identifies incomplete data fields and extracts contextual data. A data enhancement controller interacts with a natural language processing sub-controller and a large language model sub-controller to generate and process queries, populating the incomplete data fields. The system also includes a data pass-back controller that transmits the enhanced structured data files back to the property management system. The system automates the identification, enhancement, and updating of data fields, improving the accuracy and completeness of property listings.

### FIELD OF THE INVENTION

The present disclosure relates to data processing systems, specifically to systems and methods for enhancing and updating data fields within structured data files, such as those used in property listings and real estate management systems. The system automates the identification and completion of incomplete data fields, utilising techniques including natural language processing, machine learning, and computer vision to improve the accuracy and completeness of structured data files.

### BACKGROUND OF THE INVENTION

Property management systems frequently rely on the exchange of information using structured data files formatted in extensible markup languages, such as the REA (Real Estate Australia) format. These formats are designed to ensure compatibility and seamless data transfer between various systems, enabling the efficient sharing of critical information across different platforms.

However, significant technical challenges persist, particularly concerning the occurrence of incomplete data fields within these exchanged files. Incomplete data fields present a technical problem, as they can lead to inconsistencies and inaccuracies in the data, which in turn affect the integrity and reliability of the information being processed by these systems.

These technical issues can cause errors during data analysis, impede automated decision-making processes, and reduce the effectiveness of data-driven assessments. Incomplete data fields compromise the ability of property management systems to fully represent and accurately process the necessary information, highlighting the need for more robust technical solutions.

It is to be understood that, if any prior art information is referred to herein, such reference does not constitute an admission that the information forms part of the common general knowledge in the art, in Australia or any other country.

### SUMMARY OF THE DISCLOSURE

The system described herein is designed to enhance data fields within exchangeable structured data files of property listings. It features a server equipped with a processor that communicates with a memory device, where the processor retrieves data and instructions for decoding and execution. These structured data files are typically formatted in extensible markup language (XML) and may adhere to the Real Estate Australia (REA) data format in some cases.

These structured data files represent property listings, containing various data fields such as property details, descriptions, and potentially multimedia elements like images and videos. Each data field is associated with specific names and values, with some fields including free text for descriptions. However, it is common for not all data fields to be fully populated in most property listings.

To address incomplete data fields, the system employs a series of controllers. The data extraction and parsing controller is responsible for receiving the structured data files, identifying incomplete data fields, and extracting contextual data, such as property descriptions.

A central component of the system is the data enhancement controller, which interacts with several sub-controllers, including a large language model sub-controller, a natural language processing sub-controller, a machine learning sub-controller, and a computer vision sub-controller. This enhancement controller is tasked with enriching the data fields. It leverages the natural language processing sub-controller to generate queries for the large language model based on incomplete data fields and contextual information derived from property descriptions.

For example, if a property description mentions a “two-story apartment,” the system can recognise this descriptor and generate queries to determine whether the property includes internal stairs or a lift. The system may also use machine learning to further enhance the data fields by querying a trained model based on the contextual data.

Additionally, the computer vision sub-controller can analyse image or video data associated with the structured data files. This analysis helps identify and complete data fields related to visual content, such as the presence of features like a barbecue or inbuilt kitchen cupboards.

The system also incorporates a search controller for responding to user search queries and a conversational controller for generating natural language responses to user inquiries. Furthermore, a predictive targeting controller identifies client records based on specific data fields and utilises this information for targeted communication.

The overall method involves receiving structured data files from property management systems, identifying incomplete data fields, enhancing these fields using various sub-controllers, and generating enhanced structured data files. These enhanced files can be transmitted back to property management systems, client relationship management systems (CRMs), or used to generate property listing microsites or portal websites.

As such, the system integrates language models, natural language processing, machine learning, and computer vision to enrich data fields within structured data files of property listings, ensuring that the information is accurate, comprehensive, and easily searchable.

According to one aspect, there is provided a system for enhancing data fields in exchangeable structured data files of property listings. The system comprises a server in operable communication with a property management system across a wide area network, with the server including a processor executing computer program code instruction controllers. The system is designed to address the technical problem of incomplete or inaccurate data fields by employing a data extraction and parsing controller to receive structured data files, identify incomplete data fields, and extract contextual information, such as property descriptions.

The system includes a data enhancement controller that interacts with a natural language processing sub-controller and a large language model sub-controller. The data enhancement controller is configured to query the large language model based on incomplete data fields and contextual data extracted from the free text, offering a technical solution to the challenge of filling in incomplete data fields with contextually relevant information.

In accordance with an embodiment, the query generated by the natural language processing sub-controller is based on the recognition of specific descriptors in the contextual data, ensuring that the system accurately identifies and addresses relevant data fields. This solution helps in refining the system's ability to generate precise queries, enhancing the quality of the data fields.

Additionally, the system may be configured to recognize semantic equivalents of the descriptors in the contextual data, further improving the accuracy of the data enhancement process by ensuring that different terminologies or phrases lead to consistent results.

The data enhancement controller may be further configured to query the large language model sub-controller only when the natural language processing sub-controller identifies a relevant descriptor, thereby optimising the system's processing efficiency and focusing computational resources on the most pertinent data enhancement tasks.

Optionally, the system's natural language processing sub-controller is capable of generating queries for multiple incomplete data fields simultaneously, allowing the large language model to process these fields concurrently. This feature addresses the technical problem of handling multiple data gaps efficiently, reducing the time required for data enhancement.

In accordance with another embodiment, the data enhancement controller includes a machine learning sub-controller. This component is configured to query a trained model, optimised using historical contextual data and structured data files, to predict and update further missing data fields. This approach provides a predictive solution to the challenge of incomplete data fields, leveraging past data patterns to enhance current listings.

Preferably, the system also includes a computer vision sub-controller, which can determine missing data field values through the analysis of image or video data within the contextual information. This technical solution allows the system to automatically identify and update visual data-related fields, addressing the problem of integrating visual content into structured data files.

In another embodiment, the computer vision sub-controller employs object detection techniques to recognize specific objects within images or video frames, thereby ensuring that the visual content is accurately reflected in the data fields. This solution is particularly useful for identifying and cataloging features that may not be explicitly mentioned in text descriptions.

Preferably, the system is configured to validate recognised objects by querying the large language model sub-controller, ensuring that the data fields are only updated with verified information. This step provides an additional layer of accuracy, mitigating the risk of errors in data enhancement due to misinterpreted visual content.

The computer vision sub-controller may also employ image classification to assign labels or categories to images, providing a structured approach to handling visual data and enhancing the relevance of the data fields.

In a further embodiment, the computer vision sub-controller uses scene understanding techniques to infer context and elements present in a scene captured by an image or video. This approach enables the system to make more informed decisions about the content and structure of the data fields, addressing the technical problem of accurately interpreting complex visual scenes.

Preferably, the system includes a search controller configured to receive search terms, interface with the natural language processing sub-controller to identify matching data fields, and search a database of enhanced structured data files to find matching property listings. This capability offers a technical solution to the challenge of quickly and accurately retrieving relevant property data based on user queries.

In accordance with another embodiment, the system includes a conversational controller that can receive query strings, interface with the natural language processing sub-controller to identify matching data fields, and generate natural language responses. This feature enhances the system's interactivity, allowing it to provide detailed, context-aware responses to user inquiries.

Optionally, the system is designed to recognise additional data fields that were not originally included in the structured data files. This capability addresses the technical problem of adapting to new data requirements and trends in property listings, ensuring that the system remains relevant and up-to-date.

In an embodiment, the large language model sub-controller is configured to analyse text data fields within structured data files to recognize additional data fields, providing a flexible and dynamic approach to data enhancement.

Preferably, the data enhancement controller also includes a computer vision sub-controller that can recognize additional data fields through the analysis of image or video data, further expanding the system's ability to incorporate visual content into the data enhancement process.

The system may also be configured to analyse image or video data to detect scene elements, generating additional data fields based on the detected elements. This feature addresses the technical challenge of integrating rich multimedia content into structured data files.

In accordance with another embodiment, the system generates additional data fields according to the frequency of detection of scene elements, allowing it to prioritize and focus on the most commonly occurring features within visual content.

Preferably, the system's computer vision analysis is capable of detecting scene elements based on their relationship to other elements, providing a more nuanced and context-aware approach to data enhancement. This capability addresses the technical problem of interpreting complex visual data, ensuring that the system accurately reflects the content and structure of property listings.

In accordance with a further embodiment, the data enhancement controller further comprises a data creation module that interfaces with the large language model sub-controller to extract and refine video scripts from structured data files. The data creation module refines the video scripts by removing acronyms and complex terms, ensuring compatibility with synthetic video production.

Preferably, the data creation module is configured to transmit the refined video script to an API for video and voice creation. The API integrates the refined video script with a selected background image, producing a synthetic video that simulates an on-location recording.

In another embodiment, the data creation module further comprises a video creation component configured to adjust an avatar's movements and speech to align with the selected background image, thereby enhancing the realism of the synthetic video.

The system may also include a multi-modal large language model sub-controller configured to operate in real-time during property walkthroughs. The multi-modal large language model sub-controller captures and processes video and visual data to generate an automated property description.

Preferably, the multi-modal large language model sub-controller interfaces with a vision analysis sub-controller configured to process live video feeds during the property walkthrough. The vision analysis sub-controller generates descriptions of the property's features, architecture, and layout.

In accordance with another embodiment, the vision analysis sub-controller is configured to dynamically update the property description based on the live video feed, providing real-time context-aware information.

The system may further comprise an interactive open home feature configured to allow attendees to engage with the property via a mobile device application. The mobile device application is triggered by scanning a QR code and enables natural language input through text or voice.

Preferably, the interactive open home feature captures video feed data corresponding to the attendee's location within the property. The data enhancement controller is configured to process the video feed data to provide contextual information in response to queries.

In a further embodiment, the data enhancement controller utilizes pre-processed data from videos, photos, and XML files to enhance interaction and deliver contextually relevant information based on the attendee's location.

The data enhancement controller may also be configured to record and analyse interactions during the open home, with the recorded interactions being provided for subsequent analysis by property agents and sellers.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 represents a system for enhancing data fields of structured data files of property listings.

FIG. 2 illustrates the controllers, including the data extraction and parsing controller, data enhancement controller, large language model sub-controller, natural language processing sub-controller, machine learning sub-controller, computer vision sub-controller, data pass-back controller, search controller, conversational controller, and predictive targeting controller.

FIG. 3 depicts the architecture of the entire system, showing the various components and interactions.

FIG. 4 represents a machine learning system comprising a trained model and training algorithm.

FIG. 5 outlines an exemplary method for enhancing data fields of structured data files of property listings.

FIG. 6 presents a method for responding to a search query.

### DESCRIPTION OF EMBODIMENTS

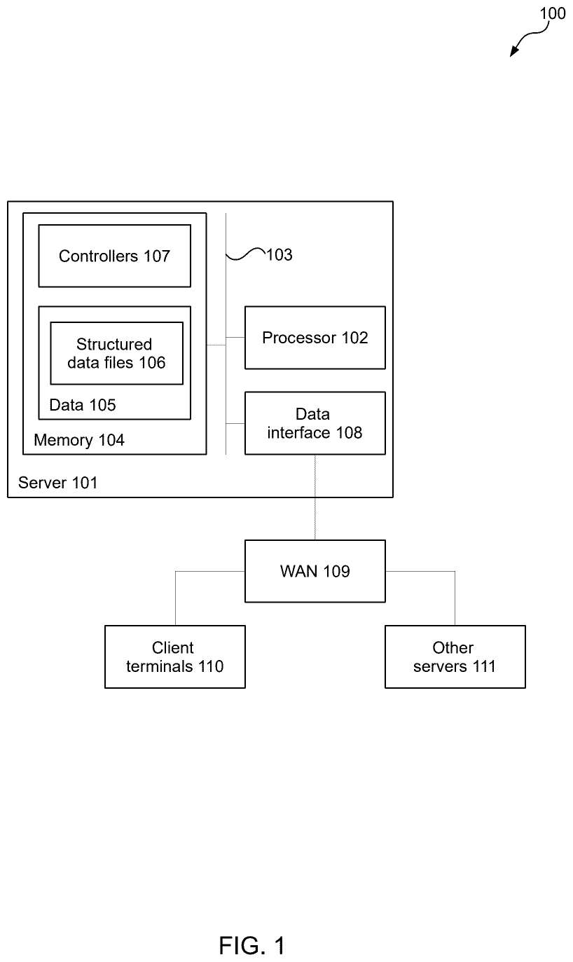

FIG. 1 shows a system 100 for enhancing data fields of structured data files of property listings. The system 100 comprises a server 101 comprising a processor 102 for processing digital data. The processor 102 is in operable communication with a memory device 104 via a system bus 103. The memory device 104 is configured for storing digital data, including computer program code instructions.

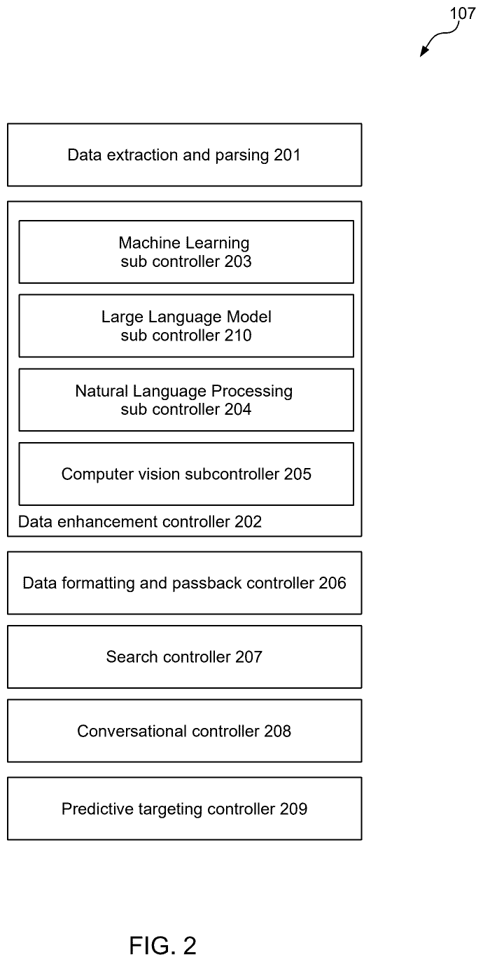

In use, the processor 102 is configured to fetch data and computer program code instructions from the memory device 104 for decoding and execution for implementing the computer functionality described herein. The computer program code instructions may be logically divided into a plurality of computer program code instruction controllers 107, which will be described in further detail below with reference to FIG. 2. The memory 104 may store data 105, including structured data files 106 of property listings.

The structured data files 106 may be in extensible markup language (XML) format. In alternative embodiments, the data fields may be accessed and/or edited by way of an API interface, such as a REST API interface. In a preferred embodiment, the structured data files 106 are in REA data format, also known as Real Estate Australia data format, which is used in Australia and other countries in the field of real estate data exchange.

The structured data file 106 comprises a plurality of data fields. Each data field comprises a name and an associated value. The structured data file 106 may further comprise free text, which may be used for property listing descriptions. The structured data file 106 typically comprises about 40 data fields relevant to property listings. However, not all data fields may be populated for every property listing.

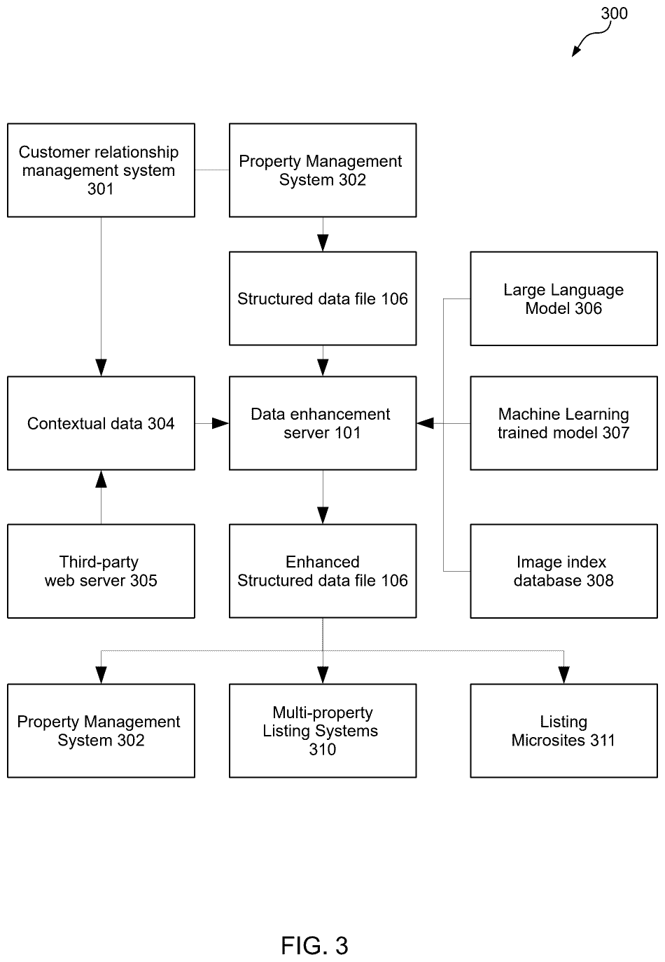

The server 101 comprises a data interface 108 for sending and receiving data across a wide area network 109, such as the Internet. In this regard, the server 101 may be in operable communication with a plurality of client terminals 110 or other servers 111. As will be described in further detail below in FIG. 3, the server 101 may be in operable communication with a property management system 302. The property management system 302 is configured to create, edit, and update data fields of structured data files 106 of property listings.

FIG. 2 shows the aforedescribed controllers 107. The controllers 107 may comprise a data extraction and parsing controller 201, which is configured to receive a structured data file 106 for a property listing from the property management system 302, which comprises populated data fields and free text. As alluded to above, the free text may represent a description of the property.

An example of a property description contained within the free text of the structured data file 106 may be as follows: “Stylish Two-Story Apartment in Prime Location. Welcome to your dream home—a stunning two-story apartment that effortlessly blends modern luxury with urban convenience. Nestled in the heart of a vibrant neighbourhood, this remarkable residence offers the best of both worlds: contemporary living spaces and a prime location that puts everything at your doorstep. Don't miss the chance to make this two-story apartment your urban oasis. Schedule a viewing today and experience luxury living like never before!”

The data fields associated with the structured data file 106 may comprise the following: Price: $1,300,000; Bedrooms: 3; Bathrooms: 2.5; Size: 367 sq m; Parking: Secure Underground

The data extraction and parsing controller 201 is further configured to identify incomplete data fields. Incomplete data fields are data fields which are either not populated with a value in the structured data file 106 or are missing entirely from the structured data file 106, such as with reference to a template data file. For example, a typical structured data file 106 used in Australia may have about 40 data fields, some of which do not have associated values. As will be described herein, the present system 100 is configured to add additional values to these unpopulated data fields to enhance the structured data file 106.

However, the template data file may have in excess of 90 candidate data fields. As such, where possible, the system 100 may be configured to add additional data fields to a structured data file 106 with reference to the candidate data fields obtained from the template data file.

In further embodiments, the system 100 is configured to dynamically identify additional potential data fields for inclusion in the template data file. In other words, as the system 100 analyses data over time, additional data fields may be recognised, which may be included in the template data file or the structured data files 106. For example, from analysing descriptive text data fields relating to electric vehicle chargers, the system 100 may add an additional Boolean data field “Has electric vehicle charger? Y/N”. Candidate additional data fields may be recognised by frequency or reoccurrence within structured data files 106.

In embodiments, computer vision analysis implemented by the present system 100 may recognise potential additional data fields from images or videos associated with properties and/or respective structured data files 106 thereof. For example, the computer vision analysis may recognise that a re-occurring scene element is ocean views, wherein the system 100 includes a new Boolean data field “Has ocean views? Y/N”.

The computer vision analysis may then also adaptively update its computer vision analysis to specifically analyse subsequent images for newly detected elements. In other words, as new candidate data fields are recognised by the system 100 and added to the template data file, subsequent computer vision analysis may specifically analyse images for each newly detected data field relating to a scene element. Some scene elements may be related to reduce computational overhead. For example, if a scene is not detected for having ocean views, the system 100 would not implement computer vision analysis to further determine whether the scene shows a beach access scene element.

In the present example, the structured data file 106 may be missing Boolean data fields for whether the property comprises internal stairs and whether the property comprises an internal lift.

The controllers 107 may further comprise a data enhancement controller 202, which is configured to enhance the data fields of the structured data file 106. The data enhancement controller 202 may be configured to operate with a plurality of sub-controllers, including a large language model sub-controller 210, a natural language processing sub-controller 204, a machine learning sub-controller 203, and/or a computer vision sub-controller 205.

In accordance with a preferred embodiment, the data enhancement controller 202 operates with the natural language processing sub-controller 204 and the large language model sub-controller to query the large language model sub-controller 210 with a query generated by the natural language processing sub-controller 204 according to a missing data field and contextual data obtained from the free text property description.

In this example, the data extraction and parsing controller 201 may have identified incomplete data fields having the names “contains internal stairs T/F” and “contains internal lift T/F”. As such, the data enhancement controller 202 may use the natural language processing sub-controller 204 to generate the following query accordingly “determine if the property described in the following text comprises a lift: [FREE TEXT]”.

The query may be generated according to the data type of the data field. For example, for a Boolean data field, the query may comprise the string “determine if” and the like. For scalar data fields, such as the number of bathrooms, the query may comprise a string “determine how many”and the like.

In embodiments, the natural language processing sub-controller 204 may generate a query to deal with multiple incomplete data fields simultaneously to reduce the number of queries against the large language model sub-controller 210. For example, in this example, the natural language processing sub-controller 204 may generate the query “determine if the property described in the following text comprises a lift or stairs?: [FREE TEXT]”.

The natural language processing sub-controller 204 may pass the response from the large language model sub-controller 210 to populate the data field values accordingly. For example, if the response from the large language model sub-controller 210 comprises the word “lift”, the data enhancement controller 202 would set the first data field in the example above to false and the second data field to true.

In this way, the data enhancement controller 202 is configured to update the incomplete data fields and the structured data file 106 with responses received from the natural language processing sub-controller 204 to generate an enhanced structured data file 106.

The controllers 107 may further comprise a data pass back controller 206, which is configured for data formatting and transmitting the enhanced structured data file to the property management system 302.

In embodiments, the query generated by the natural language processing sub-controller 204 is based on the natural language processing sub-controller 204 recognising a descriptor within the contextual data. For example, the natural language processing sub-controller 204 may be configured to recognise descriptors relating to multi-story properties. In the above example, the configured descriptors may identify keywords, including “two-storey” and their semantic equivalents, such as “upper level”. If the descriptor is recognised, the natural language processing sub-controller 204 may generate the corresponding query according to the example above to determine if the property comprises internal stairs or a lift.

In some embodiments, the data enhancement controller 202 is further configured to interface the machine learning sub-controller 203 to query the machine learning sub-controller 203 with a further missing data field and the contextual data. As such, the data enhancement controller 202 is able to update the further missing data field with a response received from the machine learning sub-controller 203 to further enhance the structured data file 106.

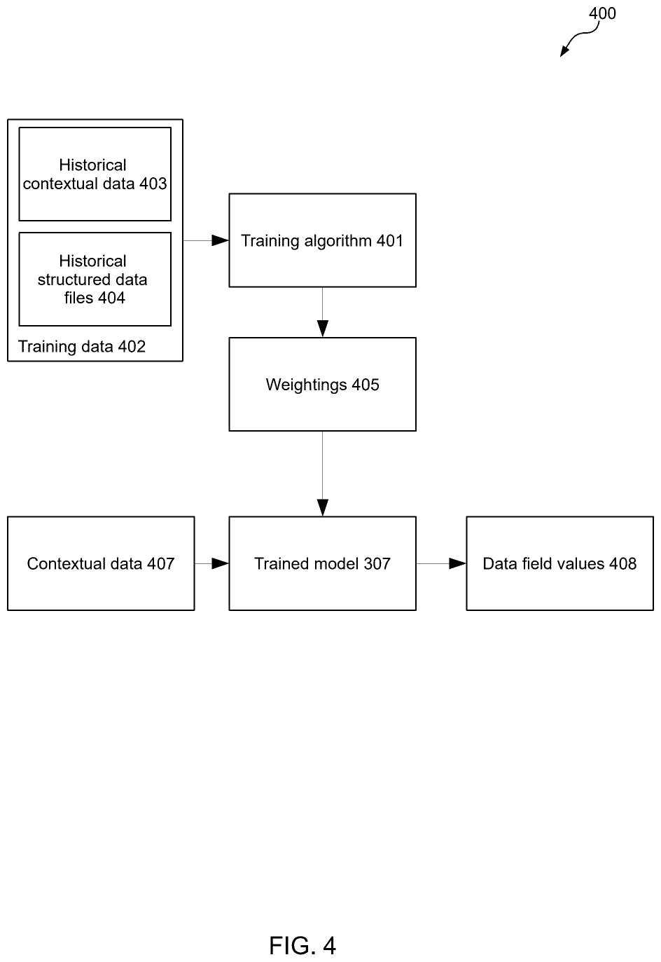

FIG. 4 shows a machine learning system 400 in accordance with an embodiment. The system 400 may comprise a trained model 307, which may take the form of an artificial neural network. The trained model 307 is optimised using a training algorithm 401, which trains using training data 402 to generate weightings 405, which optimise the nodes of the neural network of the trained model 307. The training data 402 may comprise historical contextual data 403 and historical structured data files 404. The contextual data 403 may include the free text description data from the historical structured data files 404.

Once the trained model 307 is optimised, the machine learning sub-controller 203 can query the trained model 307 with contextual data 407 (which may be free text obtained from the structured data file 106) to obtain data field values 408, which are used to enhance the structured data file 106.

The computer vision sub-controller 205 may be configured to determine a missing data field value by computer vision analysis of image or video data within the contextual data. The image or video data may be obtained from the property management system 302. Computer vision analysis may be employed for object detection to identify and locate objects within an image or video frame. For example, object detection may be used to determine whether an image comprises inbuilt cabinetry or a microwave.

In embodiments, the large language model sub-controller 210 or the machine learning sub-controller 203 may be further queried to validate a recognised object. For example, if the object detection detects a pool within an image, the large language model sub-controller 210 can be queried with the following query: “does the following text describe a pool?:”. As such, the data enhancement controller 202 may only update the associated data field if receiving validation in this manner.

Computer vision analysis may also be used for image classification, wherein labels or categories are assigned to images, such as identifying whether an image contains a barbecue. Computer vision analysis may also be used for scene understanding by inferring the context and elements present in a scene captured by an image or video. For example, the scene understanding may identify whether a provided image represents an image of a bathroom or kitchen.

The computer vision sub-controller 205 may further interact with the natural language processing sub-controller 204 for visual captioning to generate natural language descriptions of visual content.

The controllers 107 may further comprise a search controller 207 configured to receive search terms. For example, a search term may comprise “Show me houses having no stairs, in Seaforth, and having a white kitchen”. The search controller 207 may be configured to interface the natural language processing sub-controller 204 to deconstruct the search term to identify at least one data field. In this example, the natural language processing sub-controller may identify data fields having the following names: property type, has stairs T/F, location, and kitchen colour.

As can be appreciated, some of these data fields may not be commonly used, such as kitchen colour, but which may have been identified by the data enhancement controller 202. The search controller 207 may then search a database of enhanced structured data files to identify matching property listings to generate a response to the search term.

The controllers 107 may further comprise a conversational controller 208, which may similarly receive a query string and interface the natural language processing sub-controller 204 to identify at least one data field according to the search term. The conversational controller 208 may then generate a natural language response by interfacing with the natural language processing sub-controller. The controller may also present as a chat widget within a third-party web portal (such as by way of i-Frame embedding or client-side code) which may respond to queries. For example, when receiving a query “does this apartment have an internal lift?”, the conversational controller 208 may respond with the reply “no, it has internal stairs”.

The conversational controller 208 may furthermore be configured to automatically respond to email queries with natural language responses by querying the data fields of an enhanced structured data file 106.

The controllers 107 may further comprise a predictive targeting controller 207, which is configured to identify client records according to data fields of the enhanced structured data file. For example, the data enhancement server 101 may further be in operable communication with a customer relationship management system 301 comprising client records. Client records may further be stored in relation to property listing data fields. As such, the predictive targeting controller 207 may be configured to match data fields of an enhanced structured data file with property listing data fields associated with client records.

For example, for an enhanced structured data file 106 in relation to an apartment that has been sold, the predictive targeting controller 207 may identify matching client records for the automated transmission of an SMS campaign having text generated by the natural language processing sub-controller 204, stating “Did you know that a two-story apartment just like yours with internal stairs recently sold for above 2 million in your area?”

In embodiments, the predictive targeting controller 207 may predict properties coming onto the market, such as by analysing data stored within the customer relationship management system 301. For example, the predictive targeting controller 207 may analyse at least one of the data fields of customer records and electronic client communications (including frequency and keyword contents thereof) to predict when a property associated with a customer record is likely to come on the market.

FIG. 3 shows the exemplary architecture 300 of the system 100. The system 100 comprises the aforedescribed data enhancement server 101. The large language model sub-controller 210 may interface a large language model 306. A large language model 306 may be hosted externally of the data enhancement server 101. The machine learning sub-controller 203 may further interface the machine learning trained model 307. The computer vision sub-controller 205 may further interface with an image index database 308 comprising image or video data and indexed by associated metadata generated by the computer vision sub-controller 205.

The data enhancement server 101 may receive the structured data file 106 from the property management system 302, which may include the contextual data 304 as alluded to above. However, the data enhancement server 101 may be configured to obtain contextual data 304 from other sources, including third-party web server 305, multi-property listing systems 310, and the like. Contextual data may even be obtained from the client relationship management system 310. For example, a data field of the structured data file 106 may represent the last sold value. Whereas this information may not be contained within the description text included within the structured data file 106, the data enhancement controller 202 may query the multi-property listing system 310 to ascertain such data.

The data enhancement server 101 generates the enhanced structured data file 106, which may be pushed back to the property management system 302 by the data push-back controller 206 via an appropriate API interface. The enhanced structured data file 106 may further be syndicated to other computer systems. For example, the enhanced structured data file 106 may be pushed into the multi-property listing system 310 to display additional data fields. The enhanced structured data file 106 may be used to generate property listing microsites 311 hosted by a web server of the server 101 or another server 111.

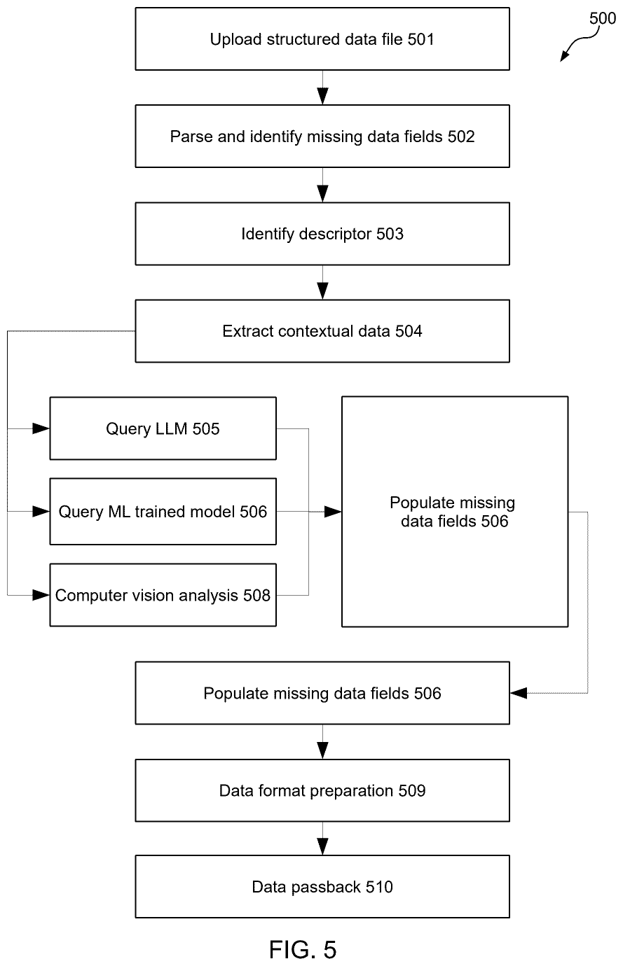

FIG. 5 shows an exemplary method 500 of operation of the present system 100 for enhancing data fields of structured data files of property listings in accordance with a specific example. In accordance with this example, the property agent creates a property listing for a two-bedroom apartment and inserts the relevant data into the property management system 302, which generates the associated structured data file 106 accordingly. In accordance with this example, the structured data file 106 comprises the above example free text as a property description and the above data fields relating to the price, number of bedrooms, number of bathrooms, property size, and parking type.

When the property listing is created by the property management system 302, the property management system 302 is configured to push the structured data file 106 to the server 101 at step 501. Upon receipt, the data extraction and parsing controller 201 recognises incomplete data fields at step 502, including data fields having the following names: “has internal lift T/F”and “has internal stairs T/F”.

The data enhancement controller 202 then seeks to update or insert these incomplete data fields. As alluded to above, the data enhancement controller 202 may be configured to only attempt to update a missing data field depending on the natural language processing sub-controller 204 recognising a descriptor within the contextual data at step 503. In this example, the natural language processing sub-controller 204 recognises the descriptor “two-storey” within the free text and therefore the data enhancement controller 202 attempts to enhance these related data fields. In other words, if the natural language processing sub-controller 204 identifies that the property is a single-story property or is not able to identify that the property has two stories, the data enhancement controller 202 would not attempt to update the associated data fields.

At step 504, the data enhancement controller 202 would extract the contextual data. As alluded to above, the contextual data may be the free text description of the property contained within the structured data file 106. However, the data enhancement controller 202 may query other sources, such as the aforedescribed multi-property listing system 310.

At step 505, the data enhancement controller 202 queries the large language model sub-controller 210 to populate incomplete data fields at step 506. For any further remaining incomplete data fields, the data enhancement controller 202 may further query the machine learning sub-controller 203 at step 506 to populate further incomplete data fields. At step 508, the data enhancement controller 202 may interface with the computer vision sub-controller 205 to populate any incomplete data fields obtainable from image or video data associated with the contextual data. As alluded to above, these incomplete data fields may comprise data fields having the following names, as an example: “has barbecue T/F”, “has inbuilt kitchen cupboards T/F”, “kitchen colour”.

As alluded to above, scene understanding may be used to identify a kitchen scene in an image, whereafter object detection may be used to determine the presence of inbuilt kitchen cupboards therein to update the “has inbuilt kitchen cupboards T/F”data field.

Once the data enhancement controller 202 has generated the enhanced structured data file 106, the data pass-back controller 206 may reformat the enhanced structured data file 106 into various formats for transmittal back to the property management system 302 and other computer systems, such as the multi-property listing system 310 or microsites 311 at step 510.

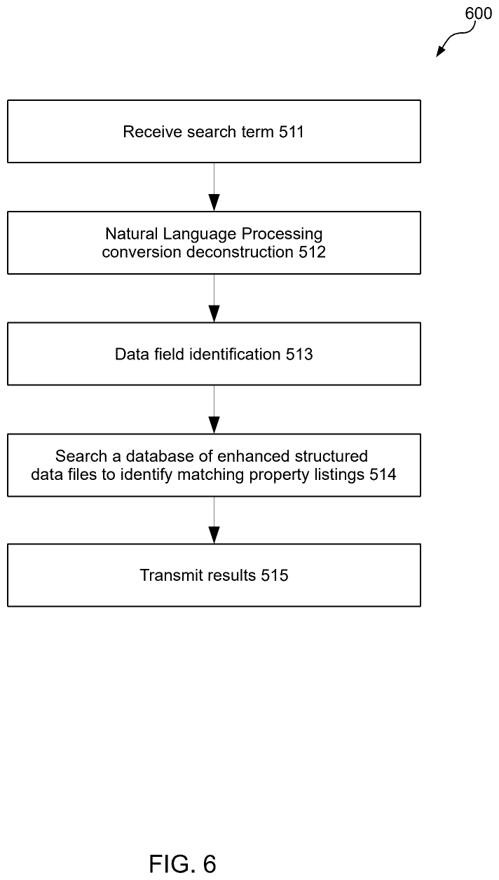

FIG. 6 shows a method 600 of the system 100 for responding to a search query. At step 511, the server 101 may receive the following search term: “Show me houses having no stairs, in Seaforth, and having a white kitchen”. At step 512, the search controller 207 may interface with the natural language processing sub-controller 204 to deconstruct the search term to identify matching data fields. In this example, the natural language processing sub-controller 204 may identify data fields having the following names: property type, has stairs T/F, location, and kitchen colour. Having identified the data fields and the associated values, the search controller 207 can then search a database of enhanced structured data files 106 to retrieve copies matching the provided search term at step 514 for transmittal in response at step 515.

In further embodiments, the system 100 is enhanced with a data creation module that interfaces with a large language model (LLM) to facilitate the extraction of video scripts from structured data files 106. This module ensures that the generated scripts are suitable for synthetic video production by eliminating acronyms and any complex or hard-to-pronounce words. The video script, once refined, is passed to an API configured for video and voice creation. The API integrates the script with a selected background image that is representative of the property. The image is passed to the video creation component, ensuring that the synthetic video appears as if it was recorded on location outside the property.

In this embodiment, the data creation module works in conjunction with the data enhancement controller 202, leveraging the capabilities of the large language model sub-controller 210. The sub-controller identifies and refines the content of the video script by processing the contextual data 304 extracted from the structured data file 106. The enhanced video script is then transmitted to the video and voice creation API. The API utilises the script alongside the selected background image to generate a synthetic video. This video features an avatar that appears to be speaking outside the property, thus providing a seamless and realistic video presentation of the property listing.

The system 100 ensures that the video script's language is natural and clear, suitable for voice synthesis, by automatically removing any acronyms or terms that may be difficult to pronounce. This preprocessing step enhances the overall quality and accessibility of the generated synthetic video content. Furthermore, the system 100 allows for the integration of additional multimedia elements, such as background music or visual effects, into the synthetic video. These enhancements can be customised based on user preferences or specific requirements of the property listing.

The video creation component is also configured to adapt the avatar's movements and speech to match the background image, further enhancing the illusion that the avatar is present at the property location. This feature is particularly valuable in real estate marketing, where creating a realistic and engaging presentation of the property expands the functionality of the system 100, providing a comprehensive solution for generating high-quality, realistic synthetic videos for property listings.

In another embodiment, the system 100 is further enhanced with the integration of a multi-modal large language model (LLM) that operates in real-time during physical property walkthroughs. This enhancement allows for the capture and processing of both video and visual data as an agent walks through the property, providing an automated and detailed description of the property.

The multi-modal LLM is connected to the system's 100 vision analysis sub-controller, which processes the live video feed captured during the walkthrough. The LLM interprets the visual and video data, enabling the generation of a comprehensive description of the property in real-time. During the walkthrough, the LLM multi-modal video input is fed into the vision system 100, which is responsible for analysing the property's features, layout, and details. The vision system uses this input to build a detailed description that includes information about the property's architecture, room layouts, furnishings, and other relevant details.

This real-time processing capability allows the agent to receive immediate feedback and descriptions, which can be used for creating property listings, client reports, or other marketing purposes. The system 100 leverages the LLM's ability to understand and describe complex visual data, ensuring that the descriptions are accurate, detailed, and tailored to the property's unique characteristics.

In this embodiment, the vision system is further enhanced to interact with the LLM multi-modal input, allowing for dynamic updates to the property description as new areas of the property are explored. The system 100 can also highlight key features or areas of interest based on the agent's focus during the walkthrough, making the description more relevant and context-specific.

The integration of the multi-modal LLM with the vision system offers a significant advantage in automating the process of property description. This not only saves time but also ensures consistency and accuracy in the descriptions provided, reducing the need for manual input and potential human error. The generated descriptions can be directly integrated into the structured data files 106 of the property listing, enhancing the overall data quality and richness of the listing. Additionally, this integration allows for the creation of enhanced multimedia presentations that combine video, images, and textual descriptions, offering potential buyers or renters a comprehensive view of the property. The system 100, therefore, provides a technical solution for real estate agents to enhance their property listings.

In a further embodiment, the system 100 is enhanced with a user-interactive feature that allows open home attendees to engage with the property through their mobile devices. This is initiated when the user steps into the open home and scans a QR code, which triggers the opening of a phone application connected to the system 100. Once the application is launched, the attendee can utilise both video and voice modalities to interact with the system in real-time. The system 100 is configured to handle natural language input, allowing the attendee to ask questions or request information about the property via text or voice while they walk around the home.

As the attendee moves through the property, the system's video feed captures the context of each room or location they enter. This real-time video feed is analysed by the system's vision analysis sub-controller, providing relevant contextual information to the large language model (LLM) sub-controller 210, which processes the user's queries. The system 100 uses data previously extracted and processed from videos, photos, and XML file ingestion, along with data augmentation techniques, to enhance the interaction. This enriched data is passed to the conversational controller 208, ensuring that the attendee receives the most accurate and relevant information tailored to their specific location within the property.

For instance, if the attendee enters the kitchen and asks about the appliances, the system 100 recognises the location and context from the video feed and accesses the augmented data related to the kitchen. The system 100 then provides detailed information about the appliances, such as brands, energy ratings, and installation dates, through a natural language response.

The integration of video and voice modalities, along with real-time data processing, allows the open home attendee to have an immersive and informative experience. The system 100 not only enhances the attendee's understanding of the property but also enables them to engage with the home in a dynamic and personalised manner. This use case builds upon the system's existing capabilities, integrating real-time multi-modal inputs with advanced data processing to deliver an enriched user experience. The combination of live video context, voice interaction, and pre-processed data ensures that the attendee receives comprehensive and contextually relevant information during their visit.

The information gathered through these interactions can be logged and analysed by the system 100, providing valuable insights for property agents and sellers. This data can be used to tailor future interactions or to improve the overall presentation of the property in subsequent open homes. The interactive open home feature represents as advancement in property viewing technology, offering a sophisticated tool for enhancing the property buying experience and providing agents with actionable data to improve client engagement.

In light if the foregoing, the present system 100 provides technical solutions to address issues related to enhancing data fields within exchangeable structured data files of property listings. One technical solution is the data extraction and parsing controller 201, which is configured to identify incomplete data fields within structured data files and extract relevant contextual data from property descriptions. This automated process reduces the need for manual data entry, improving the accuracy and completeness of the data fields.

To address the challenge of contextually enhancing incomplete data fields, the system 100 includes a data enhancement controller 202 that interacts with multiple sub-controllers. The natural language processing sub-controller 204 generates queries based on the contextual data, which are processed by the large language model sub-controller 210 to provide responses that populate the incomplete data fields accurately.

The system 100 also addresses the problem of dynamically recognising and incorporating new or additional data fields into structured data files. The machine learning sub-controller 203 can predict and update missing data fields based on patterns learned from historical data. This capability allows the system 100 to adapt to changes in data requirements and trends in property listings.

Further, the computer vision sub-controller 205 may be configured to analyse image and video data to determine missing data field values related to visual content. This analysis may include object detection, image classification, and scene understanding, enabling the system 100 to update data fields based on visual elements present in the property listings.

The system 100 may include an interactive open home feature that addresses the need for real-time data interaction during property walkthroughs. This feature captures video feed data corresponding to an attendee's location within the property and processes this data to provide contextual information in response to user queries.

Additionally, the system 100 may be capable of logging and analysing user interactions during open home events, allowing for subsequent analysis by property agents and sellers. This logging mechanism ensures that all interactions are captured and available for review, contributing to more informed decision-making.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A system for enhancing data fields in exchangeable structured data files of property listings, the system comprising a server in operable communication with a property management system across a wide area network, the server comprising a processor executing computer program code instruction controllers comprising:
a data extraction and parsing controller configured to:
receive a structured data file for a property listing from the property management system, the structured data file comprising populated data fields and free text; and
identify incomplete data fields;
a data enhancement controller comprising:
a natural language processing sub-controller; and
a large language model sub-controller, wherein the data enhancement controller is configured to:
query the large language model sub-controller with a query generated by the natural language processing sub-controller according to a missing data field and contextual data obtained from the free text;
update the missing data field in the structured data file with a response received from the natural language processing sub-controller to generate an enhanced structured data file; and
a data pass-back controller configured to transmit the enhanced structured data file to the property management system.

2. The system as claimed in claim 1, wherein the query is based on the natural language processing sub-controller recognising a descriptor in the contextual data.

3. The system as claimed in claim 2, wherein the descriptor is associated with at least one data field.

4. The system as claimed in claim 2, wherein the natural language processing sub-controller is configured to identify semantic equivalents of the descriptor in the contextual data.

5. The system as claimed in claim 2, wherein the data enhancement controller is configured to query the large language model sub-controller only when the natural language processing sub-controller recognises the descriptor in the contextual data.

6. The system as claimed in claim 1, wherein the natural language processing sub-controller is configured to generate the query according to multiple incomplete data fields to query the large language model sub-controller simultaneously for the multiple incomplete data fields.

7. The system as claimed in claim 1, wherein the data enhancement controller further comprises a machine learning sub-controller and wherein the data enhancement controller is further configured to:
query the machine learning sub-controller with a further missing data field and the contextual data; and
update the further missing data field with a response received from the machine learning sub-controller to generate the enhanced structured data file.

8. The system as claimed in claim 7, wherein the machine learning sub-controller interfaces with a trained model optimised using historical contextual data and historical structured data files.

9. The system as claimed in claim 1, wherein the data enhancement controller further comprises a computer vision sub-controller which is configured to determine a missing data field value by computer vision analysis of at least one of image and video data within the contextual data.

10. The system as claimed in claim 9, wherein the computer vision analysis employs object detection to recognise objects within an image or video frame.

11. The system as claimed in claim 10, wherein the data enhancement controller is configured to query the large language model sub-controller to validate a recognised object.

12. The system as claimed in claim 11, wherein the data enhancement controller is configured to only update a data field if receiving validation of the recognised object from the large language model sub-controller.

13. The system as claimed in claim 9, wherein the computer vision analysis employs image classification to assign labels or categories to images.

14. The system as claimed in claim 9, wherein the computer vision analysis employs scene understanding to infer context and elements present in a scene captured by an image or video.

15. The system as claimed in claim 9, wherein the computer vision sub-controller is firstly configured to employ scene understanding to infer a context and then object identification to identify an object within the context.

16. The system as claimed in claim 1, wherein the controllers further comprise a search controller configured to:
receive a search term;
interface with the natural language processing sub-controller to identify matching data fields according to the search term; and
search a database of enhanced structured data files to identify matching property listings using the matching data fields.

17. The system as claimed in claim 1, wherein the controllers further comprise a conversational controller configured to:
receive a query string;
interface with the natural language processing sub-controller to identify matching data fields according to the query string; and
interface with the natural language processing sub-controller to generate a natural language response according to values of the matching data fields and the search term.

18. The system as claimed in claim 1, wherein the system is configured to recognise additional data fields from structured data file data fields.

19. The system as claimed in claim 18, wherein the large language model sub-controller is configured to analyse text data fields within structured data files to recognise the additional data fields.

20. The system as claimed in claim 18, wherein the data enhancement controller further comprises a computer vision sub-controller which is configured to recognise the additional data fields by computer vision analysis of at least one of image and video data.

21. The system as claimed in claim 20, wherein the computer vision analysis is configured to analyse at least one of image and video data to detect scene elements.

22. The system as claimed in claim 21, wherein the additional data fields are generated according to the detected scene elements.

23. The system as claimed in claim 21, wherein the additional data fields are generated according to the frequency of detection of the detected scene elements.

24. The system as claimed in claim 21, wherein the computer vision analysis subsequently analyses at least one of image and video data to detect the scene elements according to data fields relating to the detected scene elements.

25. The system as claimed in claim 24, wherein the detected scene elements are related and wherein the computer vision analysis is configured to detect a scene element dependent on the detection of another related scene element.

26. The system as claimed in claim 1, wherein the data enhancement controller further comprises a data creation module configured to interface with the large language model sub-controller to extract and refine video scripts from the structured data files, removing acronyms and complex terms to ensure compatibility with synthetic video production.

27. The system as claimed in claim 26, wherein the data creation module is further configured to transmit the refined video script to an API for video and voice creation, wherein the API integrates the refined video script with a selected background image, producing a synthetic video that simulates an on-location recording.

28. The system as claimed in claim 27, wherein the data creation module further comprises a video creation component configured to adjust an avatar's movements and speech to align with the selected background image, thereby enhancing the realism of the synthetic video.

29. The system as claimed in claim 1, wherein the data enhancement controller further comprises a multi-modal large language model sub-controller configured to operate in real-time during property walkthroughs, the multi-modal large language model sub-controller capturing and processing video and visual data to generate an automated property description, wherein the multi-modal large language model sub-controller interfaces with a vision analysis sub-controller, the vision analysis sub-controller configured to process live video feeds during the property walkthrough, generating descriptions of the property's features, architecture, and layout and wherein the vision analysis sub-controller is further configured to dynamically update the property description based on the live video feed, thereby providing real-time context-aware information.

30. The system as claimed in claim 1, wherein the data enhancement controller further comprises an interactive open home feature, the interactive open home feature configured to allow attendees to engage with the property via a mobile device application, the mobile device application being triggered by scanning a QR code and enabling natural language input through text or voice, wherein the interactive open home feature is further configured to capture video feed data corresponding to the attendee's location within the property, and wherein the data enhancement controller is configured to process the video feed data to provide contextual information in response to queries and wherein the data enhancement controller is further configured to utilize pre-processed data from videos, photos, and XML files to enhance interaction and deliver contextually relevant information based on the attendee's location.
